(19) United States
(12) Patent Application Publication
(10) Pub. No.: US 2021/0090133 A1
(43) Pub. Date: Mar. 25, 2021

(54) DYNAMIC VALUATION OF CONFIGURABLE EQUIPMENT

(71) Applicant: Daniel T. Hamling, Oceanside, CA (US)

(72) Inventor: Daniel T. Hamling, Oceanside, CA (US)

(21) Appl. No.: 17/021,098

(22) Filed: Sep. 15, 2020

Related U.S. Application Data
(60) Provisional application No. 62/903,583, filed on Sep. 20, 2019.

(51) Int. Cl. G06Q 30/02; G06N 20/00

(52) U.S. Cl. CPC G06Q 30/0278; G06N 20/00

(57) ABSTRACT

Techniques are presented for applying fine-grained equipment configuration information to a valuation predictive model to determine one or more values associated with the equipment. Certain event data associated with a set of equipment are collected from a variety of data sources to continually train and adjust the valuation predictive model. The event data might pertain to sales transactions, equipment reconfiguration events, and/or other events associated with the equipment. At certain moments in time and/or in response to certain events associated with the equipment, valuation requests are received and applied to the valuation predictive model to determine a valuation response. The techniques disclosed herein are used to accurately track the value of highly-configurable equipment over its lifecycle.

### RELATED APPLICATIONS

This present application claims the benefit of priority to co-pending U.S. Patent Application Ser. No. 62/903,583, titled “DYNAMIC VALUATION OF CONFIGURABLE EQUIPMENT” (Attorney Docket No. DTH-P0008-01-US), filed Sep. 20, 2019, which is hereby incorporated by reference in its entirety.

### FIELD

This disclosure relates to equipment valuation, and more particularly to techniques for dynamic valuation of configurable equipment.

### BACKGROUND

Knowledge of the then-current value and/or future value of an asset is critical in effectively managing the asset throughout its lifecycle. Consider an item of equipment used in a manufacturing environment. In this case, knowing the purchase price of the equipment is important when deciding whether to acquire the equipment. The expected future use and/or value of the equipment may also be an important factor in a procurement decision. Such value information may also facilitate a buy or lease decision. At various moments in time over the lifecycle of the equipment, the value of the equipment is also important. For example, when the equipment has reached or is approaching a period of time during which the equipment is expected to be idle, knowledge of the then-current value of the equipment will be helpful in making a “keep-or-sell” decision.

Many modern equipment in manufacturing or other environments are highly configurable. Such a variety of configurations can impact the value of the equipment. Consider, for example, two manufacturing tools that both cost US$1M to acquire. A first tool is configured with a mainstream configuration that is used by many users, whereas a second tool is configured with a specialized configuration that is customized for a particular user. In this case, the first tool will most likely have a higher future value (e.g., in 3 years) than the second tool. Moreover, the configurations of certain equipment are often very dynamic, sometimes changing on a weekly or even daily or even hourly basis. As merely one example, test equipment used to test semiconductor components can be configured in real-time based at least in part on the test requirements of the components.

Unfortunately, there is no mechanism to efficiently and accurately determine the value of such highly configurable equipment. Many valuation approaches are primarily based on the original equipment cost (OEC), which can produce inaccurate value estimates if the configuration of the equipment has changed over time. In other cases, adjustments to value based on the configuration of the equipment may be performed but are derived from configuration information and/or other market inputs that are obsolete and/or too coarse, resulting in inaccurate results. What is needed is a way to accurately value highly configurable equipment in real-time.

### SUMMARY

The present disclosure describes techniques used in systems, methods, and in computer program products for dynamic valuation of configurable equipment, which techniques advance the relevant technologies to address technological issues with legacy approaches. Certain embodiments are directed to technological solutions for applying then-current fine-grained equipment configuration information to a predictive model to determine one or more values associated with the equipment.

The disclosed embodiments modify and improve over legacy approaches. In particular, the herein-disclosed techniques provide technical solutions that address the technical problems attendant to determining the value of highly configurable equipment. Some of such technical solutions involve specific implementations (i.e., data organization, data communication paths, module-to-module interrelationships, etc.) that relate to the software arts for improving computer functionality. For example, the disclosed predictive model access various data structures that are configured so as to reduce the latency and/or computing resource consumption when determining values for a wide variety of equipment. More specifically, the data structures as disclosed herein and their use serve to reduce both memory usage and CPU cycles as compared to alternative approaches.

The ordered combination of steps of the embodiments serve in the context of practical applications that perform steps for applying then-current fine-grained equipment configuration information to a predictive model to determine one or more values associated with the equipment. Specifically, the disclosed embodiments for dynamically determining values of highly configurable equipment involves technological solutions that pertain to technological problems that arise in the hardware and software arts that underlie the highly configurable equipment. Specifically, such technological problems include problems that pertain to hardware and software arts that facilitate dynamic, real-time reconfiguration of complex manufacturing equipment. Aspects of the present disclosure achieve performance and other improvements in peripheral technical fields including (but not limited to) asset management and manufacturing capacity management.

Further details of aspects, objectives, and advantages of the technological embodiments are described herein, and in the drawings and claims.

### BRIEF DESCRIPTION OF THE DRAWINGS

The drawings described below are for illustration purposes only. The drawings are not intended to limit the scope of the present disclosure.

FIG. 1 illustrates a computing environment in which embodiments of the present disclosure can be implemented.

FIG. 2 depicts a dynamic equipment valuation technique as implemented in systems that facilitate dynamic valuation of configurable equipment, according to an embodiment.

FIG. 3 is a block diagram of a system that performs dynamic valuation of configurable equipment, according to an embodiment.

FIG. 4 illustrates a data management technique as used to dynamically determine the value of configurable equipment, according to an embodiment.

FIG. 5 presents a valuation scenario as implemented in systems that facilitate dynamic valuation of configurable equipment, according to an embodiment.

FIG. 6 depicts system components as arrangements of computing modules that are interconnected so as to implement certain of the herein-disclosed embodiments.

FIG. 7 presents a block diagram of a computer system architecture having components suitable for implementing embodiments of the present disclosure, and/or for use in the herein-described environments.

### DETAILED DESCRIPTION

Aspects of the present disclosure solve problems associated with efficiently determining accurate values of highly configurable equipment. These problems are unique to, and may have been created by, various computer-implemented methods for configuring certain equipment in the context of manufacturing ecosystems or other ecosystems. Some embodiments are directed to approaches for applying then-current fine-grained equipment configuration information to a predictive model to determine one or more values associated with the equipment. The accompanying figures and discussions herein present example environments, systems, methods, and computer program products for handling dynamic valuation of configurable equipment.

### Overview

Disclosed herein are techniques for applying then-current fine-grained equipment configuration information to a predictive model to determine one or more values associated with the equipment. In certain embodiments, the predictive model is a valuation predictive model comprising one or more learning models, such as a cost model, a trend model, a value model, and/or other learning models. Certain event data associated with a set of equipment are collected to initially establish and train the valuation predictive model. The event data might pertain to sales transactions, reconfigurations, and/or other events associated with the equipment. Additional event data is collected and used to continually adjust (e.g., teach) the value predictive model.

At certain moments in time and/or in response to certain events associated with the equipment, valuation requests are received. The request parameters that correspond to the valuation requests are applied to the valuation predictive model to determine a valuation response. As an example, a reconfiguration event associated with the particular manufacturing tool might invoke a valuation request for the tool. In this case, the valuation request might describe the then-current configuration of the tool, market conditions for the tool class, and a desired value premise (e.g., FMV, FMV-installed, FMV-removed, etc.). The foregoing parameters are then applied to the valuation predictive model to determine one or more values to be included in a valuation response. Specifically, for example, values in the valuation response might include one value that corresponds to the valuation date and a set of five future values that correspond to the next five anniversaries of the valuation date. When the valuation response is determined, the response is published to the source of the valuation request and/or other designated recipients.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### DESCRIPTIONS OF EXAMPLE EMBODIMENTS

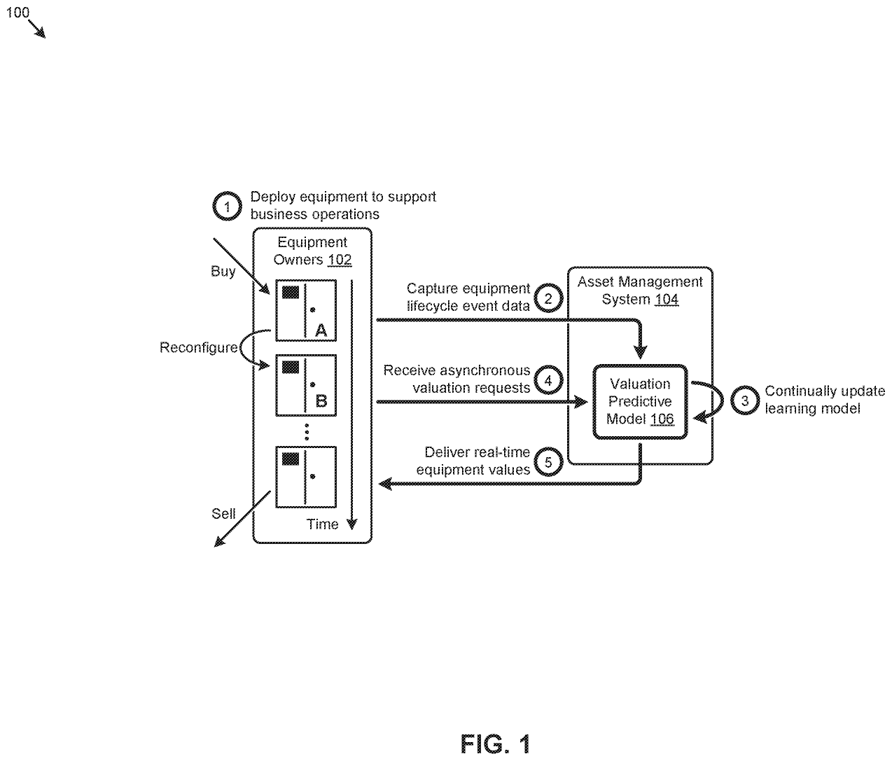

FIG. 1 illustrates a computing environment 100 in which embodiments of the present disclosure can be implemented. As an option, one or more variations of computing environment 100 or any aspect thereof may be implemented in the context of the architecture and functionality of the embodiments described herein.

FIG. 1 illustrates aspects pertaining to applying then-current fine-grained equipment configuration information to a predictive model to determine one or more values associated with the equipment. Specifically, the figure presents a logical depiction of how the herein disclosed techniques can be implemented to facilitate the delivery of real-time equipment values in the presence of equipment that undergoes continuous reconfigurations. A representative set of high order operations are also presented to illustrate how the herein disclosed techniques might be applied in computing environment 100.

The logical depiction of FIG. 1 illustrates a computing environment comprising a set of equipment owners 102 that deploy equipment to support business operations (operation 1). As shown, equipment owners 102 buy equipment, reconfigure equipment, sell equipment, and/or perform other operations over the equipment throughout the lifecycle of the equipment. To facilitate sound business decisions pertaining to the equipment, equipment owners 102 desire to have knowledge of the value of their equipment at any moment in time. As earlier mentioned, however, there is no mechanism for efficiently and accurately determining the value of such highly configurable equipment.

The herein disclosed techniques address such deficiencies attendant to determining the value of highly configurable equipment at least in part by applying then-current fine-grained equipment configuration information to a valuation predictive model 106 to determine one or more values associated with the equipment. As used herein, a learning model, such as valuation predictive model 106 and/or other learning models described herein, are a collection of mathematical techniques (e.g., algorithms) that facilitate determining (e.g., predicting) a set of outputs (e.g., outcomes, responses) based on a set of inputs (e.g., stimuli). For example, valuation predictive model 106 might consume equipment configuration attributes and other information as inputs to predict a set of values as outputs. In some cases, the techniques implemented by the model might comprise a set of equations having coefficients that relate one or more of the input variables to one or more of the output variables. In these cases, the equations and coefficients can be determined and/or adjusted by a training process.

As can be observed, valuation predictive model 106 is implemented at an asset management system 104 that captures event data over the lifecycle of the equipment associated with equipment owners 102 (operation 2). This event data and/or other information are used to generate, train, adjust, and/or otherwise continually update the valuation predictive model 106 (operation 3). When valuation requests are asynchronously received at asset management system 104 (operation 4), the parameters associated with the requests are applied to valuation predictive model 106 to deliver sets of real-time equipment values to the equipment owners 102 (operation 5).

One embodiment of techniques for dynamically determining values of highly configurable equipment is disclosed in further detail as follows.

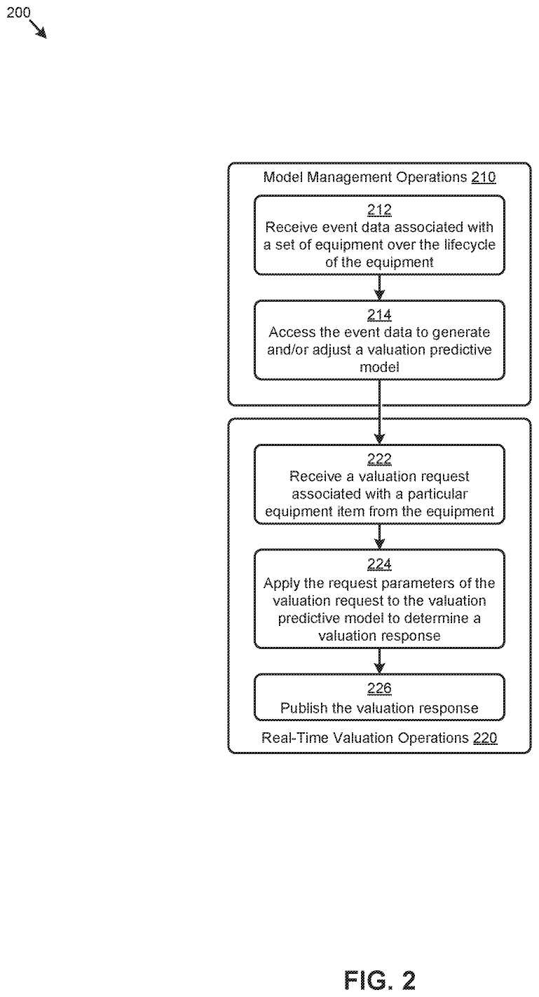

FIG. 2 depicts a dynamic equipment valuation technique 200 as implemented in systems that facilitate dynamic valuation of configurable equipment. As an option, one or more variations of dynamic equipment valuation technique 200 or any aspect thereof may be implemented in the context of the architecture and functionality of the embodiments described herein. The dynamic equipment valuation technique 200 or any aspect thereof may be implemented in any environment.

FIG. 2 illustrates aspects pertaining to applying then-current fine-grained equipment configuration information to a predictive model to determine one or more values associated with the equipment. Specifically, the figure is presented to illustrate one embodiment of certain steps and/or operations performed over a network of devices (e.g., user devices, servers, computing systems, etc.) to dynamically determine values of highly configurable equipment. As can be observed, the steps and/or operations can be grouped into a set of model management operations 210 and a set of real-time valuation operations 220.

The model management operations 210 of dynamic equipment valuation technique 200 commences by receiving event data associated with a set of equipment, the event data being continuously received over the lifecycle of the equipment (step 212). Some or all of the event data is accessed to generate and/or adjust a valuation predictive model (step 214). According to the real-time valuation operations 220, a valuation request associated with a particular equipment item from the equipment is received (step 222). At least some of the request parameters that correspond to the valuation request are applied to the valuation predictive model to determine a valuation response (step 224). As an example, the valuation response might comprise one value that corresponds to the valuation date and a set of five future values that correspond to the next five anniversaries of the valuation date. When the valuation response is determined, the response is published to the source of the valuation request and/or other designated recipients (step 226).

One embodiment of a system, data flows, and data structures for implementing the dynamic equipment valuation technique 200 and/or other herein disclosed techniques, is disclosed as follows.

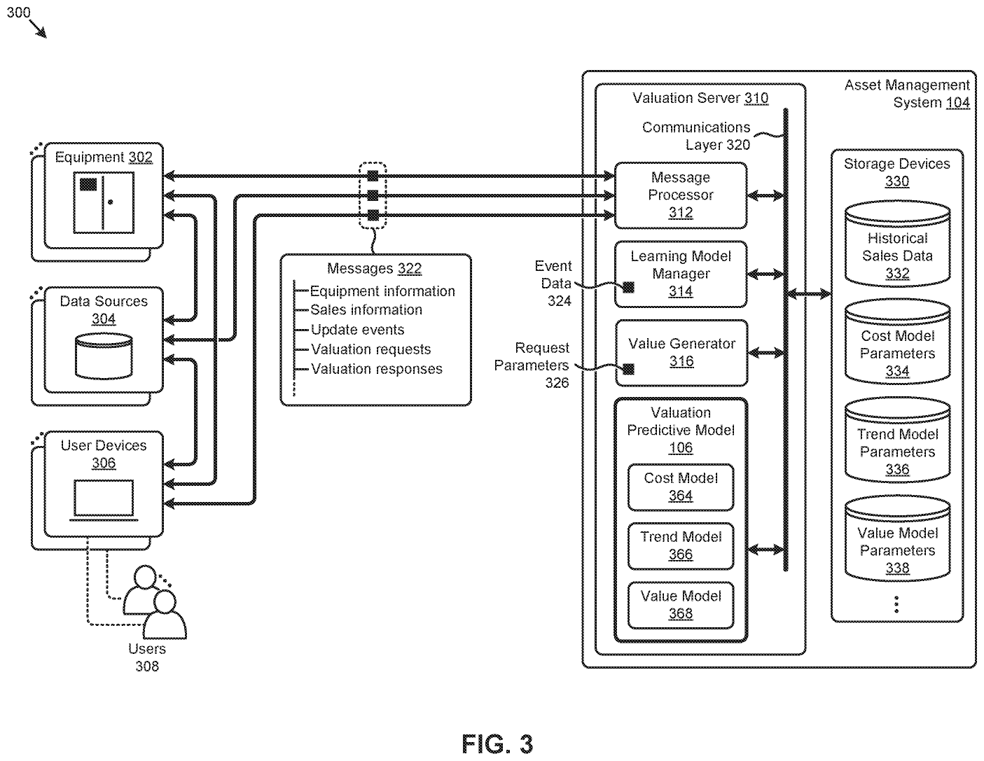

FIG. 3 is a block diagram of a system 300 performs dynamic valuation of configurable equipment. As an option, one or more variations of system 300 or any aspect thereof may be implemented in the context of the architecture and functionality of the embodiments described herein. The system 300 or any aspect thereof may be implemented in any environment.

FIG. 3 illustrates aspects pertaining to applying then-current fine-grained equipment configuration information to a predictive model to determine one or more values associated with the equipment. Specifically, the figure is being presented to show one embodiment of certain representative components and associated data structures and data flows implemented in a computing environment to facilitate the herein disclosed techniques. The components, data flows, and data structures shown in FIG. 3 present one partitioning and associated data manipulation approach. The specific example shown is purely exemplary, and other subsystems, data structures, and/or partitioning are reasonable.

As shown, system 300 comprises an instance of a valuation server 310 operating at an asset management system 104. Valuation server 310 comprises a message processor 312, a learning model manager 314, a value generator 316, and an instance of a valuation predictive model 106. Valuation predictive model 106 comprises a collection learning models including a cost model 364, a trend model 366, and a value model 368. A plurality of instances of the foregoing components might operate at a plurality of instances of servers (e.g., valuation server 310) at asset management system 104 and/or any portion of system 300. Such instances can interact with a communications layer 320 to access each other and/or a set of storage devices 330 that store various information to support the operation of the components of system 300 and/or any implementations of the herein disclosed techniques.

For example, the servers and/or storage devices of asset management system 104 might facilitate interactions with a set of equipment 302, a set of data sources 304, and a set of user devices 306 associated with user 308. Such interactions comprise instances of messages 322 transmitted between the foregoing entities in system 300. As can be observed, messages 322 are received or sent by message processor 312 at valuation server 310. In some cases, messages 322 are sent to or received from valuation server 310 without human interaction. One class of messages 322 corresponds to equipment information (e.g., equipment makes, models, options, etc.) received at asset management system 104. Message processor 312 might also receive instances of messages 322 that comprise sales information associated with equipment 302 and/or related equipment (e.g., comparable equipment). Such sales information might describe sale prices, bid prices, ask prices, fine-grained equipment configuration detail, market conditions, and/or other information pertaining to various respective sales transactions associated with equipment 302 and/or related equipment.

The aforementioned equipment information and/or sales information is often received from users 308 through their respective user devices 306. In some cases, the information might be pushed or pulled from one or more of the data sources 304 (e.g., ERP databases, etc.). Message processor 312 also receives instances of messages 322 that correspond to various update events associated with equipment 302 and/or related equipment. Such update events might correspond to a new equipment installation, an equipment configuration change, or other events. Such update event messages can be invoked automatically from equipment 302. As can be observed, equipment 302, data sources 304, and/or user devices 306 can interact with one another. As examples, equipment 302 or user devices 306 may access (e.g., read data from, write data to, etc.) one or more of the data sources 304, or user devices 306 and equipment 302 may also exchange certain data.

Various operations are performed at valuation server 310 over the data received at message processor 312. Specifically, when the sales information is received at message processor 312, the information is organized and stored in a set of historical sales data 332 in storage devices 330. Certain combinations of the sales information and the equipment information constitutes instances of event data 324 that are processed by learning model manager 314 to form the cost model 364, the trend model 366, and the value model 368. Then-current and historical model parameters that describe the cost model 364, the trend model 366, and the value model 368 are stored in sets of cost model parameters 334, trend model parameters 336, and value model parameters 338, respectively, in storage devices 330. These model parameters are updated continuously by the learning model manager 314 in response to newly received instances of event data 324 that pertain to equipment information, sales information, and/or other update event information.

When messages 322 received at message processor 312 comprise valuation requests, message processor 312 extracts instances of request parameters 326 from the valuation requests. Request parameters 326 are forwarded to value generator 316. Value generator 316 applies the request parameters 326 to the valuation predictive model 106 to generate one or more values that are to constitute a valuation response. The valuation response is returned by value generator 316 to message processor 312 to deliver as a message to the source of the corresponding valuation request. As an example, a configuration change to an equipment item in equipment 302 might invoke a valuation request to update the value of that item in a particular value tracking database in data sources 304. A user can then access the value tracking database using their user device to view the then-current value or values associated with the equipment item.

A detailed embodiment of a representative data structures that facilitate any of the techniques described herein is disclosed as follows.

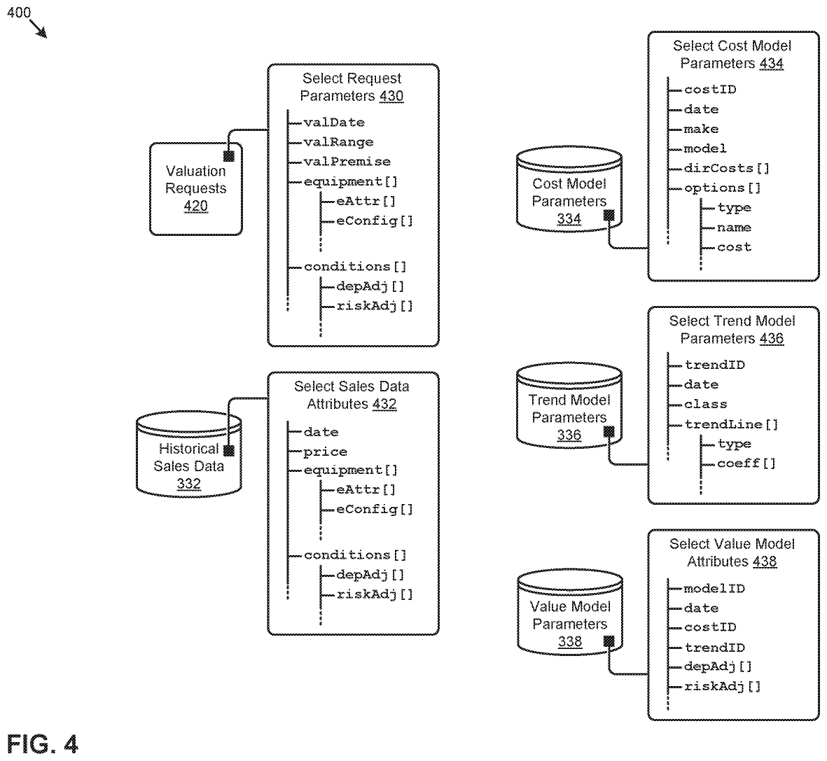

FIG. 4 illustrates a data management technique 400 as used to dynamically determine the value of configurable equipment. As an option, one or more variations of data management technique 400 or any aspect thereof may be implemented in the context of the architecture and functionality of the embodiments described herein. The data management technique 400 or any aspect thereof may be implemented in any environment.

FIG. 4 illustrates aspects pertaining to applying then-current fine-grained equipment configuration information to a predictive model to determine one or more values associated with the equipment. Specifically, the figure presents certain specialized data structures for organizing and/or storing various data to facilitate at least some of the techniques disclosed herein. These data structures and other data structures discussed herein are configured to improve the way a computer stores and retrieves certain data in memory when performing the herein disclosed techniques. Data can be organized and/or stored in accordance with these data structures using various techniques. For example, the representative data structures shown in FIG. 4 indicate that the constituent data of the data structures might be organized and/or stored in a tabular structure (e.g., relational database table) that has rows that relate various attributes with a particular data entity. As another example, the underlying data might be organized and/or stored in a programming code object that has instances corresponding to a particular data entity and properties corresponding to the various attributes associated with the data entity.

As earlier mentioned, performance of the herein disclosed techniques might involve instances of valuation requests 420, sets of historical sales data 332, sets of cost model parameters 334, sets of trend model parameters 336, sets of value model parameters 338, and/or other data.

As indicated in a set of select request parameters 430, valuation requests comprise various combinations of a valuation date (e.g., stored in a “valDate” field), a valuation date range (e.g., stored in a “valRange” field), a valuation premise (e.g., stored in a “valPremise” field), parameters describing a subject equipment item (e.g., stored in an “equipment[ ]” object), parameters describing the valuation market conditions (e.g., stored in a “conditions[ ]” object), and/or other parameters. As can be observed, the equipment information can comprise one or more equipment attributes (e.g., stored in an “eAttr[ ]” object), such as the equipment make, model, vintage or date of manufacture, physical condition, operational status, and/or other attributes. The equipment information also comprises a fine-grained description of the equipment configuration (e.g., stored in an “eConfig[ ]” object) that is to be valued. A configuration description is considered “fine-grained” when it describes a configuration at its lowest (e.g., most detailed) level of configurability. As shown, the aforementioned market conditions can comprise certain equipment depreciation adjustments (e.g., stored in a “depAdj[ ]” object), such as adjustments pertaining to price erosion, non-OEM seller discounts, physical deterioration, functional deterioration, economic obsolescence, direct costs, and/or other adjustment factors. The market conditions might also comprise certain risk adjustment factors (e.g., stored in a “riskAdj[ ]” object), such as factors pertaining to a buyer reconfiguration probability, an OEM discount probability, a reseller participation probability, a buyer power probability, and/or other risk factors.

As indicated in a set of select sales data attributes 432, sales transaction data collected and stored in historical sales data 332 comprise various combinations of a transaction date (e.g., stored in a “date” field), a transaction value (e.g., stored in a “price” field), parameters describing a subject equipment item (e.g., stored in an “equipment[ ]” object), parameters describing the transaction market conditions (e.g., stored in a “conditions[ ]” object), and/or other parameters. As can be observed, the subject equipment information can comprise one or more equipment attributes (e.g., stored in an “eAttr[ ]” object), such as the equipment make, model, vintage or date of manufacture, physical condition, operational status, and/or other attributes. The equipment information also comprises a fine-grained description of the equipment configuration (e.g., stored in an “eConfig[ ]” object) that is to be valued. A configuration description is considered “fine-grained” when it describes a configuration at its lowest (e.g., most detailed) level of configurability. As shown, the aforementioned market conditions can comprise certain equipment depreciation adjustments associated with the sales transaction (e.g., stored in a “depAdj[ ]” object), such as adjustments pertaining to price erosion, non-OEM seller discounts, physical deterioration, functional deterioration, economic obsolescence, direct costs, and/or other adjustment factors. The market conditions might also comprise certain risk adjustment factors associated with the sales transaction (e.g., stored in a “riskAdj[ ]” object), such as factors pertaining to a buyer reconfiguration probability, an OEM discount probability, a reseller participation probability, a buyer power probability, and/or other risk factors.

As indicated in a set of select cost model parameters 434, a cost model is described by various combinations of a cost model identifier (e.g., stored in a “costID” field), a model version date (e.g., stored in a “date” field), an equipment make identifier (e.g., stored in a “make” field), an equipment model identifier (e.g., stored in a “model” field), one or more direct costs (e.g., stored in a “dirCosts[ ]” object), a set of fine-grained costs for the options associated with foregoing equipment make and model (e.g., stored in an “options[ ]” object), and/or other parameters. As can be observed, the option cost information can comprise an option type (e.g., stored in a “type” field), an option name (e.g., stored in a “name” field), an option cost (e.g., stored in a “cost” field), and/or other option cost parameters.

As indicated in a set of select trend model parameters 436, a trend model is described by various combinations of a trend model identifier (e.g., stored in a “trendID” field), a model version date (e.g., stored in a “date” field), an equipment class identifier (e.g., stored in a “class” field), one or more trendline parameters (e.g., stored in a “trendLine[ ]” object), and/or other parameters. As can be observed, the trendline parameters can comprise a trendline type (e.g., stored in a “type” field), a set of coefficients for the trendline (e.g., stored in a “coeff[ ]” object), and/or other option cost parameters.

As indicated in a set of select value model parameters 438, a value model is described by various combinations of a value model identifier (e.g., stored in a “modelID” field), a model version date (e.g., stored in a “date” field), a cost model identifier (e.g., stored in a “costID” field), a trend model identifier (e.g., stored in a “trendID” field), certain default equipment depreciation adjustments (e.g., stored in a “depAdj[ ]” object), certain default risk adjustment factors (e.g., stored in a “riskAdj[ ]” object), and/or other parameters.

One representative example of a valuation approach for a fair market value (FMV) premise as facilitated by the herein disclosed techniques is disclosed in further detail as follows.

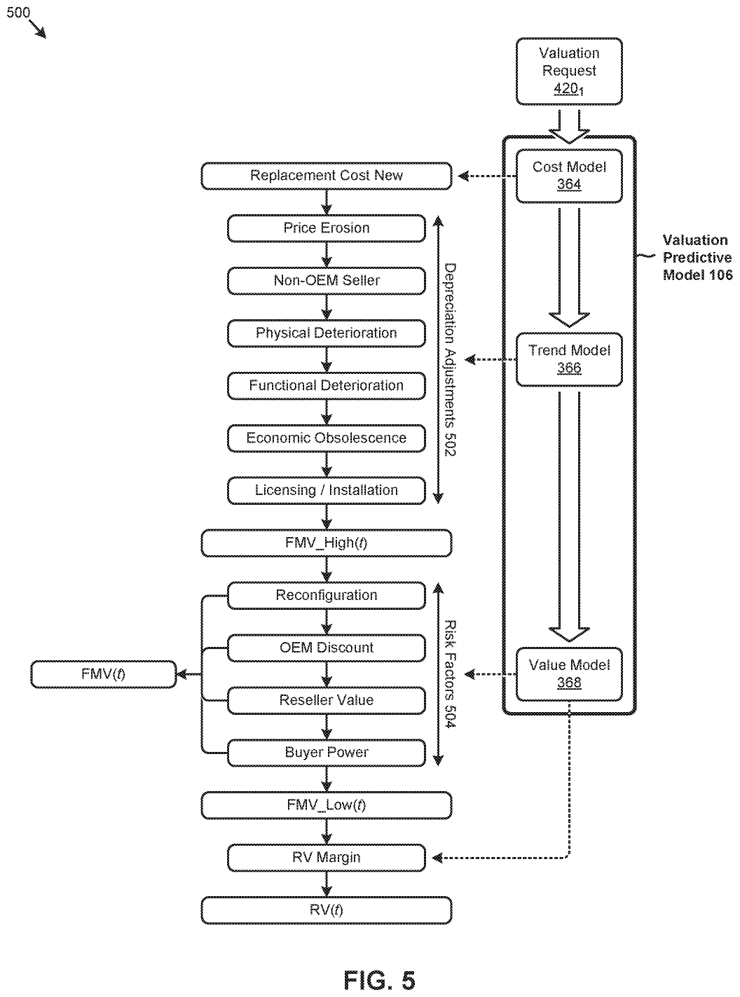

FIG. 5 presents a valuation scenario 500 as implemented in systems that facilitate dynamic valuation of configurable equipment. As an option, one or more variations of valuation scenario 500 or any aspect thereof may be implemented in the context of the architecture and functionality of the embodiments described herein. The valuation scenario 500 or any aspect thereof may be implemented in any environment.

FIG. 5 illustrates aspects pertaining to applying then-current fine-grained equipment configuration information to a predictive model to determine one or more values associated with the equipment. Specifically, the figure is presented to illustrate a representative valuation scenario that includes a set of related time-based values that are determined in real time by the techniques disclosed herein. As depicted in the figure, the set of values include one or more high fair market values (e.g., FMV_High(t)) one or more low fair market values (e.g., FMV_Low(t)), one or more fair market values (e.g., FMV(t)), and one or more residual values (e.g., RV(t)).

As shown, for a particular time t, the foregoing values are derived at least in part from a replacement cost new (RCN) that is discounted by one or more depreciation adjustments 502 to determine FMV_High(t). According to the herein disclosed techniques, the RCN is determined by applying fine-grained equipment configuration details (e.g., from a valuation request 402₁) to cost model 364 of valuation predictive model 106. Specifically, cost model 364 produces an RCN from the adjusted average selling prices (ASPs) of the same or similar equipment, adjusted based at least in part on the equipment configuration details. In some cases, the RCN may be derived from an indexed OEC or other historical cost. As can be observed, depreciation adjustments 502 and/or other adjustments are derived at least in part from trend model 366 of valuation predictive model 106 to determine FMV_High(t) from RCN. Such depreciation adjustments are often determined from historical value trends associated with a given asset class. Such value trends from trend model 365 can be applied to determine both then-current values and future values. In some cases, trend model 366 is represented by an nth-order, logarithmic, exponential, and/or other function that fits a set of historical value trend data. In such cases, the DC offset constant of the functions can be used to adjust the trend model to recently received data (e.g., sales comparables).

One or more risk factors 504 determine a difference between FMV_High(t) and FMV_Low(t). The respective probabilities corresponding to the risk factors are used to determine an expected single-value FMV(t). For example, when there are no risks (e.g., probability of each risk element is null), FMV(t) will equal FMV_High(t). As a comparison, when all risk factors are expected to apply (e.g., probability of each risk element is 100%), FMV(t) will equal FMV_Low(t). Such risk factor probabilities are often derived from expected then-current market behaviors. A residual value RV(t) is derived from FMV_Low(t) based at least in part on a residual value (RV) margin. As shown, risk factors 504 and their respective then-current probabilities, the RV margin, and/or other information used to determine the aforementioned FMVs and RV are codified in value model 368 of valuation predictive model 106, as disclosed herein. Specifically, value model 368 might comprise logic, parameters, and/or other data objects to generate FMV_High(t), FMV_Low(t), FMV(t), and RV(t) for a single moment in time or over a horizon of time (e.g., as specified in valuation request 420₁).

### Additional Embodiments of the Disclosure

### Instruction Code Examples

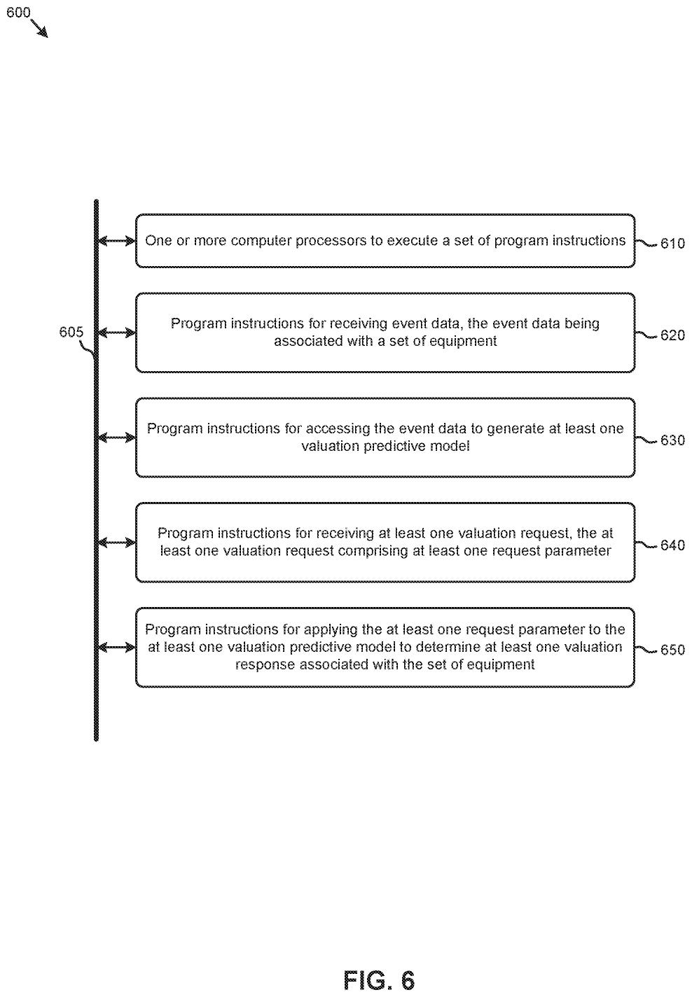

FIG. 6 depicts a system 600 as an arrangement of computing modules that are interconnected so as to operate cooperatively to implement certain of the herein-disclosed embodiments. This and other embodiments present particular arrangements of elements that, individually or as combined, serve to form improved technological processes that address efficiently sharing workflows over multiple enterprises and environments. The partitioning of system 600 is merely illustrative and other partitions are possible.

The system 600 comprises at least one processor and at least one memory, the memory serving to store program instructions corresponding to the operations of the system. As shown, an operation can be implemented in whole or in part using program instructions accessible by a module. The modules are connected to a communication path 605, and any operation can communicate with other operations over communication path 605. The modules of the system can, individually or in combination, perform method operations within system 600. Any operations performed within system 600 may be performed in any order unless as may be specified in the claims. The shown embodiment implements a portion of a computer system, presented as system 600, comprising a computer processor to execute a set of program code instructions (module 610) and modules for accessing memory to hold program code instructions to perform: receiving event data, the event data being associated with a set of equipment (module 620); accessing the event data to generate at least one valuation predictive model (module 630); receiving at least one valuation request, the at least one valuation request comprising at least one request parameter (module 640); and applying the at least one request parameter to the at least one valuation predictive model to determine at least one valuation response associated with the set of equipment (module 650).

Variations of the foregoing may include more or fewer of the shown modules. Certain variations may perform more or fewer (or different) steps and/or certain variations may use data elements in more, or in fewer, or in different operations.

### System Architecture Overview

### Additional System Architecture Example

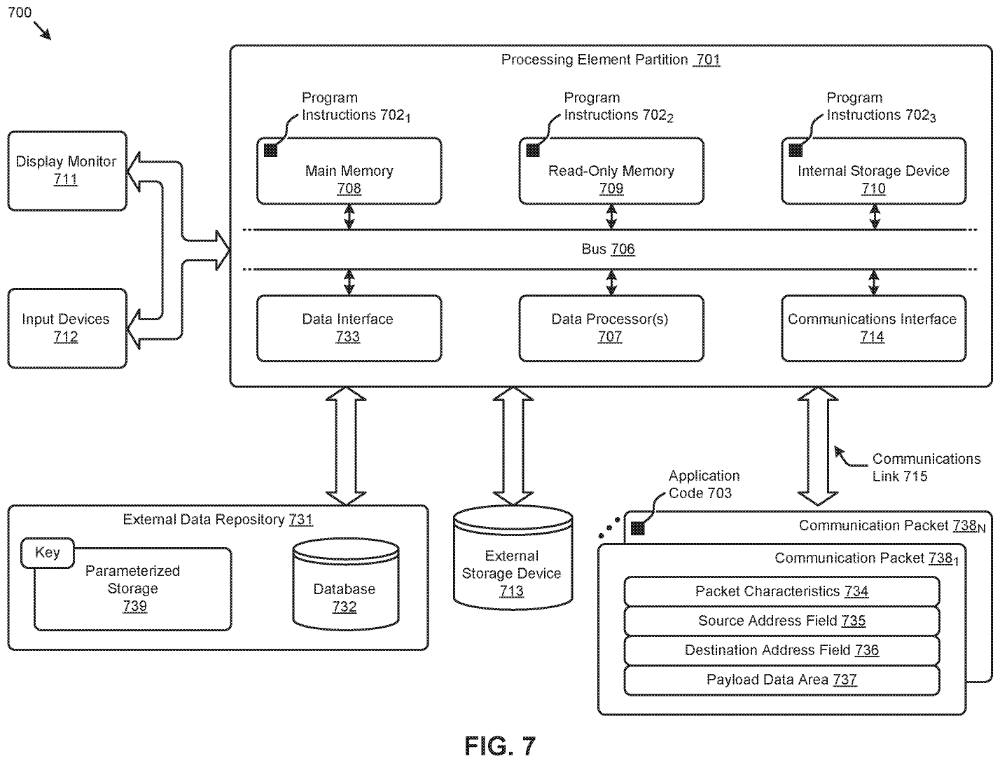

FIG. 7 depicts a block diagram of an instance of a computer system 700 suitable for implementing embodiments of the present disclosure. Computer system 700 includes a bus 706 or other communication mechanism for communicating information. The bus interconnects subsystems and devices such as a central processing unit (CPU), or a multi-core CPU (e.g., data processor 707), a system memory (e.g., main memory 708, or an area of random access memory (RAM)), a non-volatile storage device or non-volatile storage area (e.g., read-only memory 709), an internal storage device 710 or external storage device 713 (e.g., magnetic or optical), a data interface 733, a communications interface 714 (e.g., PHY, MAC, Ethernet interface, modem, etc.). The aforementioned components are shown within processing element partition 701, however other partitions are possible. Computer system 700 further comprises a display 711 (e.g., CRT or LCD), various input devices 712 (e.g., keyboard, cursor control), and an external data repository 731.

According to an embodiment of the disclosure, computer system 700 performs specific operations by data processor 707 executing one or more sequences of one or more program instructions contained in a memory. Such instructions (e.g., program instructions 702₁, program instructions 702₂, program instructions 702₃, etc.) can be contained in or can be read into a storage location or memory from any computer readable/usable storage medium such as a static storage device or a disk drive. The sequences can be organized to be accessed by one or more processing entities configured to execute a single process or configured to execute multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

According to an embodiment of the disclosure, computer system 700 performs specific networking operations using one or more instances of communications interface 714. Instances of communications interface 714 may comprise one or more networking ports that are configurable (e.g., pertaining to speed, protocol, physical layer characteristics, media access characteristics, etc.) and any particular instance of communications interface 714 or port thereto can be configured differently from any other particular instance. Portions of a communication protocol can be carried out in whole or in part by any instance of communications interface 714, and data (e.g., packets, data structures, bit fields, etc.) can be positioned in storage locations within communications interface 714, or within system memory, and such data can be accessed (e.g., using random access addressing, or using direct memory access DMA, etc.) by devices such as data processor 707.

Communications link 715 can be configured to transmit (e.g., send, receive, signal, etc.) any types of communications packets (e.g., communication packet 738₁, communication packet 738_{N}) comprising any organization of data items. The data items can comprise a payload data area 737, a destination address 736 (e.g., a destination IP address), a source address 735 (e.g., a source IP address), and can include various encodings or formatting of bit fields to populate packet characteristics 734. In some cases, the packet characteristics include a version identifier, a packet or payload length, a traffic class, a flow label, etc. In some cases, payload data area 737 comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to data processor 707 for execution. Such a medium may take many forms including, but not limited to, non-volatile media and volatile media. Non-volatile media includes, for example, optical or magnetic disks such as disk drives or tape drives. Volatile media includes dynamic memory such as RAM.

Common forms of computer readable media include, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory computer readable medium. Such data can be stored, for example, in any form of external data repository 731, which in turn can be formatted into any one or more storage areas, and which can comprise parameterized storage 739 accessible by a key (e.g., filename, table name, block address, offset address, etc.).

Execution of the sequences of instructions to practice certain embodiments of the disclosure are performed by a single instance of a computer system 700. According to certain embodiments of the disclosure, two or more instances of computer system 700 coupled by a communications link 715 (e.g., LAN, public switched telephone network, or wireless network) may perform the sequence of instructions required to practice embodiments of the disclosure using two or more instances of components of computer system 700.

Computer system 700 may transmit and receive messages such as data and/or instructions organized into a data structure (e.g., communications packets). The data structure can include program instructions (e.g., application code 703), communicated through communications link 715 and communications interface 714. Received program instructions may be executed by data processor 707 as it is received and/or stored in the shown storage device or in or upon any other non-volatile storage for later execution. Computer system 700 may communicate through a data interface 733 to a database 732 on an external data repository 731. Data items in a database can be accessed using a primary key (e.g., a relational database primary key).

Processing element partition 701 is merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor 707. Some embodiments include one or more special-purpose hardware components (e.g., power control, logic, sensors, transducers, etc.). Some embodiments of a module include instructions that are stored in a memory for execution so as to facilitate operational and/or performance characteristics pertaining to processing dynamic valuation of configurable equipment. A module may include one or more state machines and/or combinational logic used to implement or facilitate the operational and/or performance characteristics pertaining to processing dynamic valuation of configurable equipment.

Various implementations of database 732 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of dynamic valuation of configurable equipment). Such files, records, or data structures can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to forming and handling dynamic valuation of configurable equipment, and/or for improving the way data is manipulated when performing computerized operations pertaining to the herein disclosed techniques.

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A method for dynamic valuation of configurable equipment, the method comprising:
receiving event data, the event data being associated with a set of equipment;
accessing the event data to generate at least one valuation predictive model;
receiving at least one valuation request, the at least one valuation request comprising at least one request parameter; and
applying the at least one request parameter to the at least one valuation predictive model to determine at least one valuation response associated with the set of equipment.

2. The method of claim 1, wherein the at least one valuation predictive model is trained by a first portion of the event data.

3. The method of claim 1, wherein the at least one valuation predictive model is adjusted by a second portion of the event data.

4. The method of claim 1, wherein the at least one valuation request is invoked in response to at least one event associated with the set of equipment.

5. The method of claim 1, wherein the at least one valuation response comprises one or more values and one or more valuation dates that correspond to the one or more values.

6. The method of claim 1, wherein the at least one valuation response is published to one or more recipients.

7. The method of claim 1, wherein the event data corresponds to at least one of, equipment information, equipment configuration information, sales information, or update event information.

8. The method of claim 1, wherein the at least one request parameter corresponds to at least one of, one or more valuation dates, one or more valuation ranges, one or more valuation premises, one or more equipment attributes, one or more equipment configuration descriptions, one or more market conditions, one or more depreciation adjustments, or one or more risk adjustments.

9. A computer readable medium, embodied in a non-transitory computer readable medium, the non-transitory computer readable medium having stored thereon a sequence of instructions which, when stored in memory and executed by one or more processors causes the one or more processors to perform a set of acts for dynamic valuation of configurable equipment, the set the acts comprising:
receiving event data, the event data being associated with a set of equipment;
accessing the event data to generate at least one valuation predictive model;
receiving at least one valuation request, the at least one valuation request comprising at least one request parameter; and
applying the at least one request parameter to the at least one valuation predictive model to determine at least one valuation response associated with the set of equipment.

10. The computer readable medium of claim 9, wherein the at least one valuation predictive model is trained by a first portion of the event data.

11. The computer readable medium of claim 9, wherein the at least one valuation predictive model is adjusted by a second portion of the event data.

12. The computer readable medium of claim 9, wherein the at least one valuation request is invoked in response to at least one event associated with the set of equipment.

13. The computer readable medium of claim 9, wherein the at least one valuation response comprises one or more values and one or more valuation dates that correspond to the one or more values.

14. The computer readable medium of claim 9, wherein the at least one valuation response is published to one or more recipients.

15. A system for dynamic valuation of configurable equipment, the system comprising:
a storage medium having stored thereon a sequence of instructions; and
one or more processors that execute the instructions to cause the one or more processors to perform a set of acts, the acts comprising,
receiving event data, the event data being associated with a set of equipment;
accessing the event data to generate at least one valuation predictive model;
receiving at least one valuation request, the at least one valuation request comprising at least one request parameter; and
applying the at least one request parameter to the at least one valuation predictive model to determine at least one valuation response associated with the set of equipment.

16. The system of claim 15, wherein the at least one valuation predictive model is trained by a first portion of the event data.

17. The system of claim 15, wherein the at least one valuation predictive model is adjusted by a second portion of the event data.

18. The system of claim 15, wherein the at least one valuation request is invoked in response to at least one event associated with the set of equipment.

19. The system of claim 15, wherein the at least one valuation response comprises one or more values and one or more valuation dates that correspond to the one or more values.

20. The system of claim 15, wherein the at least one valuation response is published to one or more recipients.
